(19) United States
(12) Patent Application Publication
(10) Pub. No.: US 2006/0236395 A1
(43) Pub. Date: Oct. 19, 2006

(54) System and method for conducting surveillance on a distributed network

(76) Inventors: David Barker, Sunnyvale, CA (US); Clive R. Beavis, Atherton, CA (US); Robert Alasdair Alexander Bruce, Livermore, CA (US); Joan Garrett, Mountain View, CA (US); Joshua L. Lubliner, San Jose, CA (US); Iain B. Robertson, Stirling (GB); Robert Angelo Ciccone JR., Danville, CA (US); Prasad N. Akella, Palo Alto, CA (US)

Correspondence Address: HELLER EHRMAN LLP, 275 MIDDLEFIELD ROAD, MENLO PARK, CA, 94025-3506, US

(21) Appl. No.: 11/241,728

(22) Filed: Sep. 30, 2005

Related U.S. Application Data
(60) Provisional application No. 60/615,148, filed on Sep. 30, 2004.

(51) Int. Cl. G06F 12/14

(52) U.S. Cl. 726/23

(57) ABSTRACT

A method is provided for conducting surveillance on a network. Data is captured on a network for a plurality of aggregated channels. The data is from individuals with network access identifiers that permit the individuals to gain access to the network, or applications on the network. The data is used to construct a plurality of session data streams. The session data streams provide a reconstruction of business activity participated in by the application or the individual with the network. A window of data is read in at least one of the plurality of session data streams to determine deviations. The window of data is tested against at least one filter. The at least one filter detects behavioral changes in the applications or the individuals that have the network access identifiers to access to the network. Defined intervention are taken in response to the deviations.

### CROSS REFERENCE TO RELATED APPLICATIONS

This application claims the benefit of U.S. Ser. No. 60/615,148, filed Sep. 30, 2004, which application is hereby fully incorporated herein by reference.

### BACKGROUND OF THE INVENTION

1. Field of the Invention

This invention relates generally to systems and methods for providing surveillance on a distributed network, and more particularly to systems and methods for providing surveillance on a distributed network that capture data from a plurality of aggregated channels.

2. Description of the Related Art

The explosion of telecommunications and computer networks has revolutionized the ways in which information is disseminated and shared. At any given time, massive amounts of information are exchanged electronically by millions of individuals worldwide using these networks not only for communicating but also for engaging in a wide variety of business transactions, including shopping, auctioning, financial trading, accounting, among others. While these networks provide unparalleled benefits to users, they also facilitate unlawful activity by providing a vast, inexpensive, and potentially anonymous way for accessing and distributing fraudulent information, as well as for breaching the network security through network intrusion. These transactions provide insight for segmenting a population's behavior for marketing, audit and compliance purposes.

Each of the millions of individuals exchanging information on these networks is a potential victim of network intrusion and electronic fraud. Network intrusion occurs whenever there is a breach of network security for the purposes of illegally extracting information from the network, spreading computer viruses and worms, and attacking various services provided in the network. Electronic fraud occurs whenever information that is conveyed electronically is either misrepresented or illegally intercepted for fraudulent purposes. The information may be intercepted during its transfer over the network, may be illegally accessed from various information-databases maintained-by merchants, suppliers, or consumers conducting business electronically or obtained voluntarily. These databases usually store sensitive and vulnerable information exchanged in electronic business transactions, such as credit card numbers, personal identification numbers, and billing records.

Today, examples of network intrusion and electronic fraud abound in virtually every business with an electronic presence. For example, the financial services industry is subject to credit card fraud and money laundering, the telecommunications industry is subject to cellular phone fraud, and the health care industry is subject to the misrepresentation of medical claims. All of these industries are subject to network intrusion attacks. Business losses due to electronic fraud and network intrusion have been escalating significantly since the Internet and the World Wide Web (hereinafter “the web”) have become the preferred medium for business transactions for many merchants, suppliers, and consumers. Conservative estimates foresee fraud, intrusion and identity theft losses in web-based business transactions to be in the billion-dollar range.

To address the need to prevent and detect network intrusion and electronic fraud, a variety of new technologies have been developed. Technologies for detecting and preventing network intrusion involve anomaly detection systems and signature detection systems.

Anomaly detection systems detect network intrusion by looking for user's or system's activity that does not correspond to a normal activity profile measured for the network and for the computers in the network. The activity profile is formed based on a number of statistics collected in the network, including CPU utilization, disk and file activity, user logins, TCP/IP log files, among others. The statistics must be continually updated to reflect the current state of the network. The systems may employ neural networks, data mining, agents, or expert systems to construct the activity profile. Examples of anomaly detection systems include the Computer Misuse Detection System (CMDS), developed by Science Applications International Corporation, of San Diego, Calif., and the Intrusion Detection Expert System (IDES), developed by SRI International, of Menlo Park, Calif.

With networks rapidly expanding, it becomes extremely difficult to track all the statistics required to build a normal activity profile. In addition, anomaly detection systems tend to generate a high number of false alarms, causing some users in the network that do not fit the normal activity profile to be wrongly suspected of network intrusion. Sophisticated attackers may also generate enough traffic so that it looks “normal” when in reality it is used as a disguise for later network intrusion.

Another way to detect network intrusion involves the use of signature detection systems that look for activity that corresponds to known intrusion techniques, referred to as signatures, or system vulnerabilities. Instead of trying to match user's activity to a normal activity profile like the anomaly detection systems, signature detection systems attempt to match user's activity to known abnormal activity that previously resulted in an intrusion. While these systems are very effective at detecting network intrusion without generating an overwhelming number of false alarms, they must be designed to detect each possible form of intrusion and thus must be constantly updated with signatures of new attacks. In addition, many signature detection systems have narrowly defined signatures that prevent them from detecting variants of common attacks.

To improve the performance of network detection systems, both anomaly detection and signature detection techniques have been employed together. A system that employs both includes the Next-Generation Intrusion Detection Expert System (NIDES), developed by SRI International, of Menlo Park, Calif. The NIDES system includes a rule-based signature analysis subsystem and a statistical profile-based anomaly detection subsystem.

The NIDES rule-based signature analysis subsystem employs expert rules to characterize known intrusive activity represented in activity logs, and raises alarms as matches are identified between the observed activity logs and the rule encodings. The statistical subsystem maintains historical profiles of usage per user and raises an alarm when observed activity departs from established patterns of usage for an individual. While the NIDES system has better detection rates than other purely anomaly-based or signature-based detection systems, it still suffers from a considerable number of false alarms and difficulty in updating the signatures in real-time.

Some of the techniques used by network intrusion detection systems can also be applied to detect and prevent electronic fraud. Technologies for detecting and preventing electronic fraud involve fraud scanning and verification systems, the Secure Electronic Transaction (SET) standard, and various intelligent technologies, including neural networks, data mining, multi-agents, and expert systems with case-based reasoning (CBR) and rule-based reasoning (RBR).

Fraud scanning and verification systems detect electronic fraud by comparing information transmitted by a fraudulent user against information in a number of verification databases maintained by multiple data sources, such as the United States Postal Service, financial institutions, insurance companies, telecommunications companies, among others. The verification databases store information corresponding to known cases of fraud so that when the information sent by the fraudulent user is found in the verification database, fraud is detected. An example of a fraud verification system is the iRAVES system (the Internet Real Time Address Verification Enterprise Service) developed by Intelligent Systems, Inc., of Washington, D.C.

A major drawback of these verification systems is that keeping the databases current requires the databases to be updated whenever new fraudulent activity is discovered. As a result, the fraud detection level of these systems is low since new fraudulent activities occur very often and the database gets updated only when the new fraud has already occurred and has been discovered by some other method. The verification systems simply detect electronic fraud, but cannot prevent it.

In cases of business transactions on the web involving credit card fraud, the verification systems can be used jointly with the Secure Electronic Transaction (SET) standard proposed by the leading credit card companies Visa, of Foster City, Calif., and Mastercard, of Purchase, N.Y. The SET standard provides an extra layer of protection against credit card fraud by linking credit cards with a digital signature that fulfills the same role as the physical signature used in traditional credit card transactions. Whenever a credit card transaction occurs on a web site complying with the SET standard, a digital signature is used to authenticate the identity of the credit card user.

The SET standard relies on cryptography techniques to ensure the security and confidentiality of the credit card transactions performed on the web, but it cannot guarantee that the digital signature is being misused to commit fraud. Although the SET standard reduces the costs associated with fraud and increases the level of trust on online business transactions, it does not entirely prevent fraud from occurring. Additionally, the SET standard has not been widely adopted due to its cost, computational complexity, and implementation difficulties.

To improve fraud detection rates, more sophisticated technologies such as neural networks have been used. Neural networks are designed to approximate the operation of the human brain, making them particularly useful in solving problems of identification, forecasting, planning, and data mining. A neural network can be considered as a black box that is able to predict an output pattern when it recognizes a given input pattern. The neural network must first be “trained” by having it process a large number of input patterns and showing it what output resulted from each input pattern. Once trained, the neural network is able to recognize similarities when presented with a new input pattern, resulting in a predicted output pattern. Neural networks are able to detect similarities in inputs, even though a particular input may never have been seen previously.

There are a number of different neural network algorithms available, including feed forward, back propagation, Hopfield, Kohonen, simplified fuzzy adaptive resonance (SFAM), among others. In general, several algorithms can be applied to a particular application, but there usually is an algorithm that is better suited to some kinds of applications than others.

Current fraud detection systems using neural networks generally offer one or two algorithms, with the most popular choices being feed forward and back propagation. Feed forward networks have one or more inputs that are propagated through a variable number of hidden layers or predictors, with each layer containing a variable number of neurons or nodes, until the inputs finally reach the output layer, which may also contain one or more output nodes. Feed-forward neural networks can be used for many tasks, including classification and prediction. Back propagation neural networks are feed forward networks that are traversed in both the forward (from the input to the output) and backward (from the output to the input) directions while minimizing a cost or error function that determines how well the neural network is performing with the given training set. The smaller the error and the more extensive the training, the better the neural network will perform. Examples of fraud detection systems using back propagation neural networks include Falcon™, from HNC Software, Inc., of San Diego, Calif., and PRISM, from Nestor, Inc., of Providence, R.I.

These fraud detection systems use the neural network as a predictive model to evaluate sensitive information transmitted electronically and identify potentially fraudulent activity based on learned relationships among many variables. These relationships enable the system to estimate a probability of fraud for each business transaction, so that when the probability exceeds a predetermined amount, fraud is detected. The neural network is trained with-data drawn from a database containing historical data on various business transactions, resulting in the creation of a set of variables that have been empirically determined to form more effective predictors of fraud than the original historical data. Examples of such variables include customer usage pattern profiles, transaction amount, percentage of transactions during different times of day, among others.

For neural networks to be effective in detecting fraud, there must be a large database of known cases of fraud and the methods of fraud must not change rapidly. With new methods of electronic fraud appearing daily on the Internet, neural networks are not sufficient to detect or prevent fraud in real-time. In addition, the time consuming nature of the training process, the difficulty of training the neural networks to provide a high degree of accuracy, and the fact that the desired output for each input needs to be known before the training begins are often prohibiting limitations for using neural networks when fraud is either too close to normal activity or constantly shifting as the fraudulent actors adapt to changing surveillance or technology.

To improve the detection rate of fraudulent activities, fraud detection systems have adopted intelligent technologies such as data mining, multi-agents, and expert systems with case-based reasoning (CBR) and rule-based reasoning (RBR). Data mining involves the analysis of data for relationships that have not been previously discovered. For example, the use of a particular credit card to purchase gourmet cooking books on the web may reveal a correlation with the purchase by the same credit card of gourmet food items. Data mining produces several data relationships, including: (1) associations, wherein one event is correlated to another event (e.g., purchase of gourmet cooking books close to the holiday season); (2) sequences, wherein one event leads to another later event (e.g., purchase of gourmet cooking books followed by the purchase of gourmet food ingredients); (3) classification, i.e., the recognition of patterns and a resulting new organization of data (e.g., profiles of customers who make purchases of gourmet cooking books); (4) clustering, i.e., finding and visualizing groups of facts not previously known; and (5) forecasting, i.e., discovering patterns in the data that can lead to predictions about the future.

Data mining is used to detect fraud when the data being analyzed does not correspond to any expected profile of previously found relationships. In the credit card example, if the credit card is stolen and suddenly used to purchase an unexpected number of items at odd times of day that do not correspond to the previously known customer profile or cannot be predicted based on the purchase patterns, a suspicion of fraud may be raised. Data mining can be used to both detect and prevent fraud. However, data mining has the risk of generating a high number of false alarms if the predictions are not done carefully. An example of a system using data mining to detect fraud includes the ScorXPRESS system developed by Advanced Software Applications, of Pittsburgh, Pa. The system combines data mining with neural networks to quickly detect fraudulent business transactions on the web.

Another intelligent technology that can be used to detect and prevent fraud includes the multi-agent technology. An agent is a program that gathers information or performs some other service without the user's immediate presence and on some regular schedule. A multi-agent technology consists of a group of agents, each one with an expertise interacting with each other to reach their goals. Each agent possesses assigned goals, behaviors, attributes, and a partial representation of their environment. Typically, the agents behave according to their assigned goals, but also according to their observations, acquired knowledge, and interactions with other agents. Multi-agents are self-adaptive, make effective changes at run-time, and react to new and unknown events and conditions as they arise.

These capabilities make multi-agents well suited for detecting electronic fraud. For example, multi-agents can be associated with a database of credit card numbers to classify and act on incoming credit card numbers from new electronic business transactions. The agents can be used to compare the latest transaction of the credit card number with its historical information (if any) on the database, to form credit card users' profiles, and to detect abnormal behavior of a particular credit card user. Multi-agents have also been applied to detect fraud in personal communication systems (A Multi-Agent Systems Approach for Fraud Detection in Personal Communication Systems, S. Abu-Hakima, M. Toloo, and T. White, AAAI-97 Workshop), as well as to detect network intrusion. The main problem with using multi-agents for detecting and preventing electronic fraud and network intrusion is that they are usually asynchronous, making it difficult to establish how the different agents are going to interact with each other in a timely manner.

In addition to neural networks, data mining, and multi-agents, expert systems have also been used to detect electronic fraud. An expert system is a computer program that simulates the judgment and behavior of a human or an organization that has expert knowledge -and-experience in- a-particular field. Typically,-such a system employs rule-based reasoning (RBR) and/or case-based reasoning (CBR) to reach a solution to a problem. Rule-based systems use a set of “if-then” rules to solve the problem, while case-based systems solve the problem by relying on a set of known problems or cases solved in the past. In general, case-based systems are more efficient than rule-based systems for problems involving large data sets because case-based systems search the space of what already has happened rather than the intractable space of what could happen. While rule-based systems are very good for capturing broad trends, case-based systems can be used to fill in the exceptions to the rules.

Both rule-based and case-based systems have been designed to detect electronic fraud. Rule-based systems have also been designed to detect network intrusion, such as the Next-Generation Intrusion Detection Expert System (NIDES), developed by SRI International, of Menlo Park, Calif. Examples of rule-based fraud detection systems include the Internet Fraud Screen (IFS) system developed by CyberSource Corporation, of Mountain View, Calif., and the FraudShield.™ system, developed by ClearCommerce Corporation, of Austin, Tex. An example of a case-based fraud detection system is the Minotaur.™ system, developed by Neuralt Technologies, of Hampshire, UK.

These systems combine the rule-based or casebased technologies with neural networks to assign fraud risk scores to a given transaction. The fraud risk scores are compared to a threshold to determine whether the transaction is fraudulent or not. The main disadvantage of these systems is that their fraud detection rates are highly dependent on the set of rules and cases used. To be able to identify all cases of fraud would require a prohibitive large set of rules and known cases. Moreover, these systems are not easily adaptable to new methods of fraud as the set of rules and cases can become quickly outdated with new fraud tactics.

To improve their fraud detection capability, fraud detection systems based on intelligent technologies usually combine a number of different technologies together. Since each intelligent technology is better at detecting certain types of fraud than others, combining the technologies together enables the system to cover a broader range of fraudulent transactions. As a result, higher fraud detection rates are achieved. Most often these systems combine neural networks with expert systems and/or data mining. As of today, there is no system in place that integrates neural networks, data mining, multi-agents, expert systems, and other technologies such as fuzzy logic and genetic algorithms to provide a more powerful fraud detection solution.

In addition, current fraud detection systems are not always capable of preventing fraud in real-time. These systems usually detect fraud after it has already occurred, and when they attempt to prevent fraud from occurring, they often produce false alarms. Furthermore, most of the current fraud detection systems are not self-adaptive, and require constant updates to detect new cases of fraud. Because the systems usually employ only one or two intelligent technologies that are targeted for detecting only specific cases of fraud, they cannot be used across multiple industries to achieve high fraud detection rates with different types of electronic fraud. In addition, current fraud detection systems are designed specifically for detecting and preventing electronic fraud and are therefore not able to detect and prevent network intrusion as well.

Accordingly, there is a need for systems and methods for dynamic detection and prevention of fraud that capture data from a plurality of aggregated channels. There is a further need for systems and methods for dynamic detection and prevention of electronic fraud that are self-adaptive and detect and prevent fraud in real-time. There is a further need for systems and methods for dynamic detection and prevention of electronic fraud that are more sensitive to known or unknown different types of fraud and network intrusion attacks.

### SUMMARY OF THE INVENTION

An object of the present invention is to provide systems and methods for dynamic detection and prevention of fraud that capture data from a plurality of aggregated channels.

Another object of the present invention is to provide systems and methods for dynamic detection and prevention of fraud that are self-adaptive and detect and prevent fraud in real-time.

A further object of the present invention is to provide systems and methods for dynamic detection and prevention of fraud that are more sensitive to known or unknown different types of fraud.

These and other objects of the present invention are achieved in a method for conducting surveillance on a network. Data is captured on a network for a plurality of aggregated channels. The data is from individuals with network access identifiers that permit the individuals to gain access to the network, or applications on the network. The data is used to construct a plurality of session data streams. The session data streams provide a reconstruction of business activity participated in by the application or the individual with the network. A window of data is read in at least one of the plurality of session data streams to determine deviations. The window of data is tested against at least one filter. The at least one filter detects behavioral changes in the applications or the individuals that have the network access identifiers to access to the network. Defined intervention are taken in response to the deviations.

In another embodiment of the present invention, a network surveillance system includes a network and a plurality of sensors distributed at the network that provide a plurality of session data streams. The session data streams provide a reconstruction of, an individual with network access identifiers that permit the individual to gain access to the network or business activity participated in by an application on the network. At least one analyzer engine is configured to receive the plurality of session data streams and produce an aggregated data stream that is a sequence of process steps. A reader reads a window of data in at least one of the plurality of session data streams. A filter tests the window of data and detects behavioral changes in, the individual that has the network access identifiers to access the network or the application. At least one actuator is included and provides an intervention in response to the behavior changes that are detected.

In another embodiment of the present invention, a method is provided for conducting surveillance on a network. Data is captured data from at least one channel. The data is from, individuals with transaction network access identifiers that permit the individuals to gain access to a transaction network, or applications on the transaction network. The data is used to construct a plurality of session data streams. The session data streams provide a reconstruction of business activity participated in by the application or the individual with the transaction network. The plurality of session data streams include an individual's behavior pattern information. A determination is made of, an individual's normal behavior pattern information and a population's normal behavior pattern information. A determination is made of deviations with respect to at least one of the individual's normal behavior pattern information, the population's normal behavior pattern information and a known fraud pattern. Interventions are provided in response to determining deviations with respect to at least one of, the individual's normal behavior pattern information, the population's normal behavior pattern information or the known fraud pattern.

### BRIEF DESCRIPTION OF THE DRAWINGS

FIG. 1 is a block diagram illustrated one embodiment of a network surveillance system of the present invention.

FIG. 2 is a flow chart illustrating one embodiment for method of the present invention for conducting surveillance on a network.

FIG. 3 is a flow chart illustrating one embodiment for the processing, comparing behaviors and then triggering an intervention.

FIG. 4 is a flow chart illustrating real time triggering of an intervention.

FIG. 5 is a flow chart illustrating the creation of a normal behavior vector and its corresponding compressed version.

FIG. 6 is a flow chart illustrating computing a deviation.

FIG. 7 is a flow chart illustrating the creation and identification of business event definitions.

FIG. 8 is a diagram illustrating an embodiment of the present invention where deviations of interest are transmitted to a clearing house and then to other transaction networks.

### DETAILED DESCRIPTION OF THE PREFERRED EMBODIMENTS

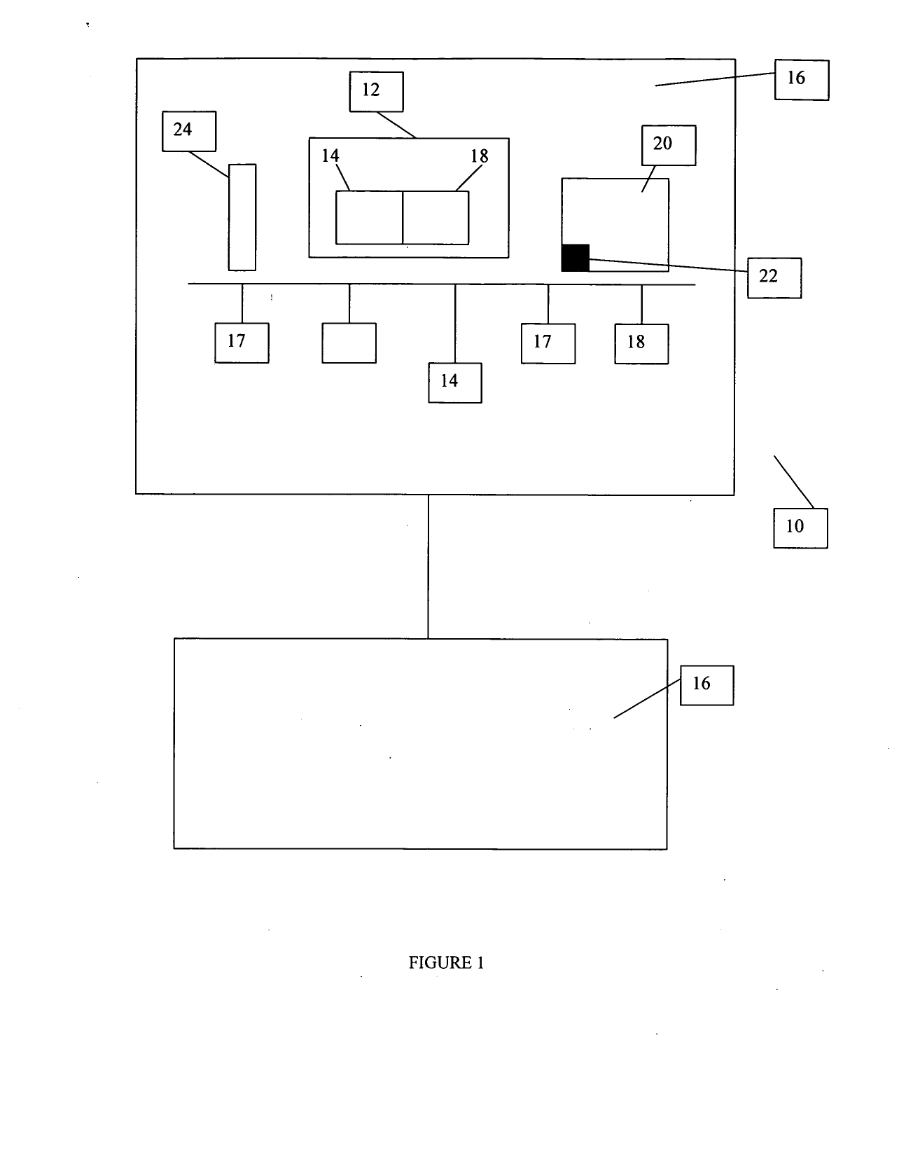

In one embodiment of the present invention, illustrated in FIG. 1, a network surveillance system 10 is provided and includes a network monitor 12, and a plurality of sensors 14 that capture data on one or more transaction networks 16. The data on these networks may or may not be encrypted for security purposes. By way of illustration, and without limitation, the sensors 14 can be network sniffers and can be resident in network monitor 12. In this embodiment, the sensors 14 sit non-intrusively on the transaction network 16 and stream raw session data that is transformed into session data at one or both of the analyzer engines for the sensor. This non-intrusive behavior is achieved without changing the robustness of the transaction network 16 and/or without modifying an application code to track the data.

In one embodiment, one or more transaction systems 17 are included with transaction network 16. The transaction systems 17 are the backend of the transaction network 16. The sensors 14 then stream the transformed session to the analyzer engines. External data, including but not limited to historical data, can be brought in.. In this embodiment, the external data is saved in some other part of the transaction network 16 and is merged with the transformed session data. The transaction network 16 can be a variety of networks, including the Internet, Intranets, wireless networks, LAN's, WAN's, and the like. An individual, user and/or customer, collectively an “individual” uses one or more transaction networks 16 as he executes his tasks.

In one embodiment, the transformed session data can be stored in record files 18. In one embodiment, the network monitor 12 includes the sensors 14 and the record files 18. The data is typically stored in a database or as flat files. The database can contain a variety of tables, with each table containing one or more data categories or fields in its columns. Each row of a table can have a unique record or instance of data for the fields defined by the columns. The database records need not be localized on any one machine but may be inherently distributed in the transaction network 16.

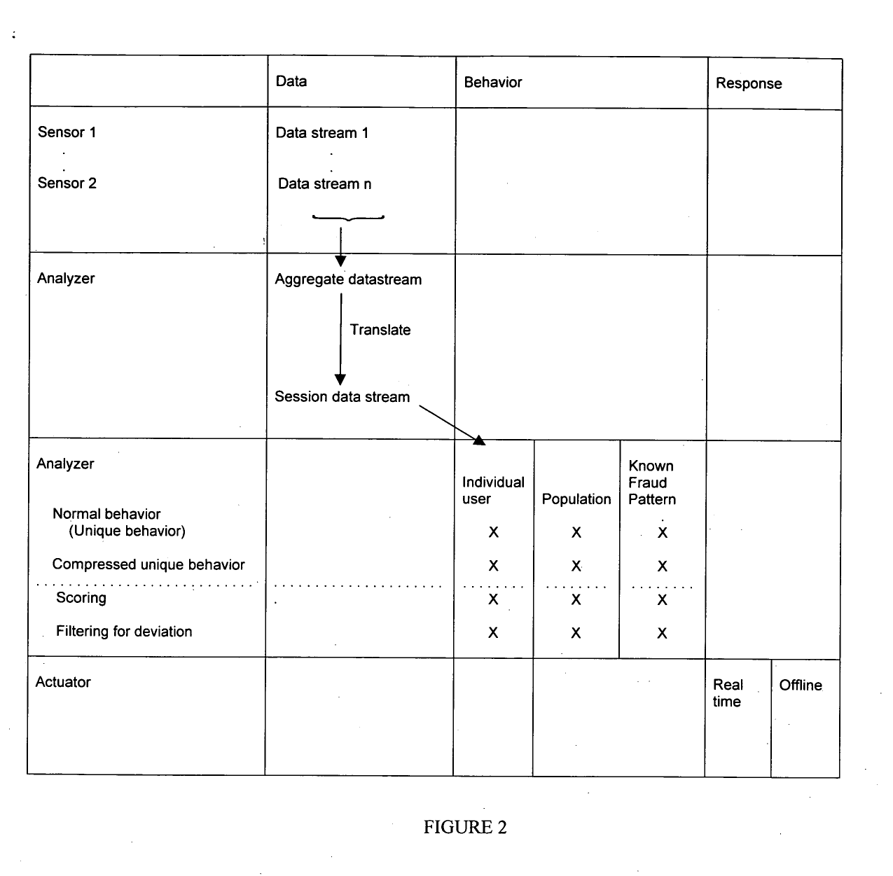

As set forth in FIG. 2, a method is provided for conducting surveillance on the transaction network 16. Data is captured for a plurality of aggregated channels. Each aggregated channel can provide information from different processes that are available on the transaction network 16. At least a portion of the different processes can be separated by fire walls.

The data is captured from applications on individuals or from the transaction network 16 with network access identifiers that permit the individuals to gain access to the transaction network 16. The data is used to construct a plurality of session data streams.

The session data streams provide a reconstruction of business activity participated in by the individual or the application with the transaction network 16. A reader 19 is provided to read a window of data in at least one of the plurality of session data streams to determine deviations. The window of data is tested against at least one filter. The filter detects behavioral changes in the individuals or applications that have the network access identifiers to access to the network. Defined intervention are taken in response to the deviations.

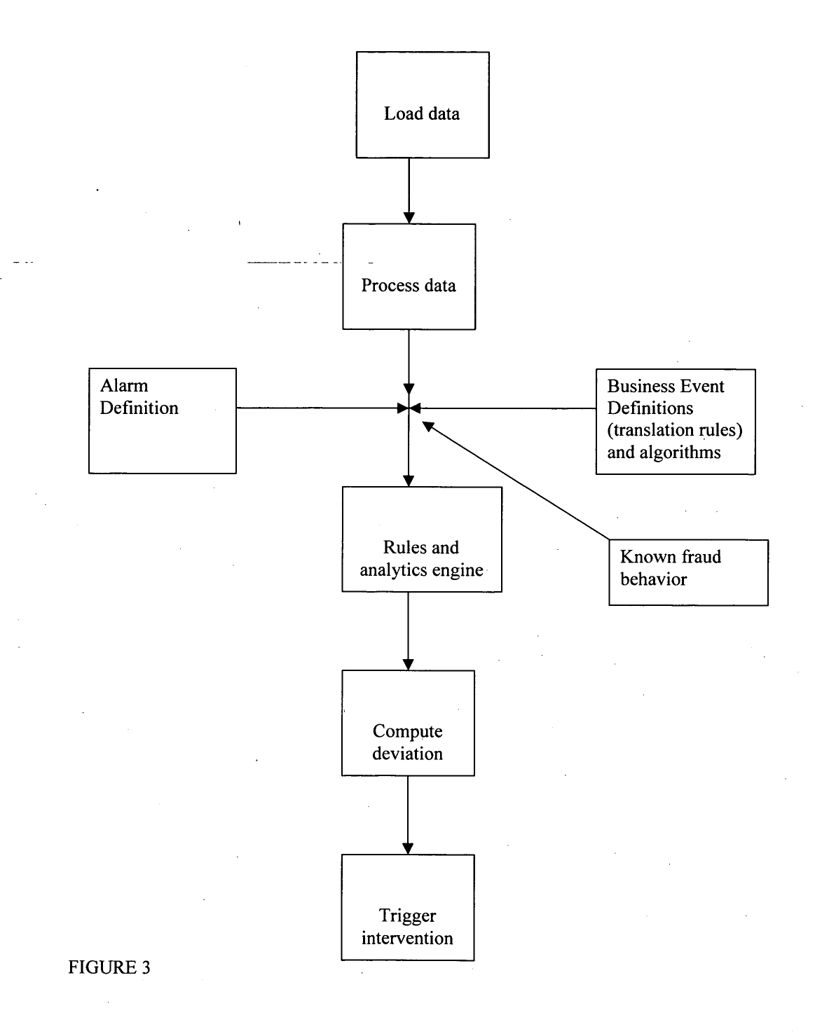

In one embodiment of the present invention, illustrated in FIG. 3, the session data stream and historical data streams are merged and transformed into formats that are appropriate for data mining purposes. At least one analyzer engine 20 is provided. The analyzer engine 20 receives the session data streams and produces an aggregated data stream that is a sequence of process steps. The analyzer engine 20 constructs the aggregated data stream over time. These formats enable the system 10 to efficiently perform an analysis of the data, such as cluster analysis, and the like.

In one embodiment, this efficiency is due to a high performance parallel data load, manipulation and query engine built into the analyzer engine 20. In one embodiment, the data load is portioned, stored and manipulated across SMP and MPP architectures. A relational table and column architecture is supported. In one embodiment, the analyzer engine 20 supports in memory manipulation of data that is further enhanced by, (i) column-oriented storage of tables (only columns involved in a query need to be memory mapped), (ii) encoding of domain data values for a column (many aggregate, clustering and sorting functions can be applied to integer based encodings), (iii) a compact representation of encoded values (e.g., bitmaps for binary valued domains), (iv) common encodings shared between common keys in the relational schema (for highly performant table joins), (v) zooming bitmap selective indices, (vi) rich boolean expression capabilities and (vii) can be combined using combinatorial logic with previously evaluated indices. In one embodiment, the analyzer engine 20 provides rich transformation expression capabilities with, (i) built-in arithmetic/string operators and (ii) hooks for C, Java custom functions to augment them. In one embodiment, the analyzer engine 20 provides virtualized denormalisations that make dimensional attributes available for query/transformation in related tables. Additional storage requirements are not required. The analyzer engine 20 is highly performant in executing in-line joins to access the dimensional attributes.

By postponing the efficient computation of the necessary analytics, the analyzer engine 20 is able to deliver the most up to date behavioral information on-demand.

The system 10 can then compute the principal descriptors of a population's and individual's behavior pattern information. By way of illustration, and without limitation, the individual can be an individual consumer conducting business electronically through one or more transaction networks 16. The principal descriptors are predictors of an individual's behavior and can be represented as a vector.

### EXAMPLE 1

Assume there are 15 descriptors that can be used to identify an individual's behavior. The system 10 looks at historical data of the individual to identity these 15 descriptors. In this 15-dimensional space, the system 10 can identify three classes of deviations. The first is due to changes with respect to the individual's normal behavior while the second is with respect to the population's (or, the closest segment of the population's) normal behavior. The third behavior change is with respect to known types of fraudulent behavior. Taken together, it becomes possible to identify deviations in the individual's behavior and identify previously unknown fraud behaviors. For example, take the simple example case of deviations from the individual's normal behavior and deviations from known fraudulent behaviors. A 2×2 matrix can be constructed as shown in Table 1.

TABLE 1

| | Hi | Lo | |
|---|---|---|---|
| Hi | Potentially new | Existing fraud pattern | Deviation from |
| | fraud pattern | | Individual Normal |
| | | | behavior |
| Lo | Behavior consistent | Noise (system's ability | |
| | with account owner | to discriminate is | |
| | | challenged) | |

Deviation from known fraud behavior

In this manner, new and previously known good and bad behavioral pattern informations can be identified. In addition, by using multiple reference behaviors, the system 10 is able to tune out false positives while increasing the percentage of true positives.

The above decision matrix, or frameworks like it, can be populated with inferences from distance functions, rules based systems, statistical analyses, algorithmic computations, neural net results, and the like. Augmentation with probabilistic attributes (confidence measures, for example), further enable quantitative manipulation and tuning of the system's 10 behaviors.

In one embodiment, the principal descriptors can include, by way of illustration and without limitation the following classes of information, (i) computing imprints and (ii) behavioral imprints.

By way of illustration, and without limitation, the computing imprints can include, (i) originating IP address(es), (ii) PC's MAC address(es), (iii) details of Browser(s) used, (iv) cookie information, (v) referrer page information, (vi) country of origin, (vii) local language and time settings and the like.

By way of illustration, and without limitation the behavioral imprints, can include (i) the time of day that the individual typically logs in, (ii) frequency of use, (iii) length of use, (iv) sequences of actions typically executed (including state and time), (v) transactions/period, (vi) transaction sizes (average, minimum and maximum), (vii) the number of and information pertaining to accounts that are typically interacted with (ABA/Swift routing data, account, and the like), (viii) average time that dollars reside in an account which may require some financial ratio in order to track, (ix) frequency of profile changes (such as name, postal address, email address, telephone, and the like), (x) the number, category and transaction sizes of electronic bill pays (EBPs) (e.g., utilities, mortgages, credit card, loans, and the like, (xi) applications and systems typically used, (xii) applications and systems authorized to use, and the like

In one embodiment, a plurality of analyzer engines 20 and sensors 14 are placed at different places on the transaction network 16. This aggregated data enables the prevention of fraudulent data due to, including but not limited to, the lack of coordination within the transaction network 16 (e.g., the bank's multitude of transaction systems.) For example, consider the following situation.

### EXAMPLE 2

A consumer establishes a checking account at a physical branch and shortly thereafter bounces several checks in a row. The consumer then uses the account number assigned when the account was opened and the PIN number assigned to his ATM card to sign up for online banking services at the bank. While the DDA history systems would contain information about the series of bounced checks, the online banking applications may have no knowledge of physical transaction history. The individual then uses the online banking applications to request an overdraft line, and then transfers money from the overdraft line to his checking account. The individual then uses his ATM card to withdraw all of the money now in the checking account.

Typically the online banking applications would have no knowledge of deposits and withdrawals made via an ATM network. In one embodiment of this system, the three channels (ATM network, DDA transaction history, and online banking) are aggregated. With data from the DDA transaction history channel the system can flag the consumer as a potential risk to use of the online banking channel and provide immediate notification that the risk consumer-has-activated-online banking services which in itself is risky behavior. The system 10 can then notify the ATM network channel that the consumer has transferred funds from an on demand credit product to provide a warning for any activity that may occur in the ATM channel.

The session data streams provide a sequential reconstruction of business activity organized by session. A window of data is read in at least one of the session data streams. The window of data is then tested against at least one filter 22. The filter 22 can be determined through statistical analyses, algorithmically or a set of rules. Business policies are translated to create at least a portion of the filter 22.

Examples of business policies include but are not limited to, (i) rules that financial institutions have on fraudulent behaviors, (ii) information pertaining to insider trading, (iii)mandatory multi-day hold on EBP transfer requests, (iv) dollar limits on online requests for money transfers mapped to ATM withdrawal limits, (v) mandatory physical signature requirements for online initiated wire transfers without of country destinations, (vi) second factor confirmation required for adding individuals to an online account service, (vii) minimum account balance restrictions and the like.

Further examples of business policies include but are not limited to, (i) a mandatory physical address required for routing of retail payments, (ii) transaction reconciliation cutoff times for processing through payment networks, (iii) buy/sell order balanced reconciliation's for investment products prior to funding, (iv) time of transaction limitations on newly issued investment products, (v) disclosure requirements for activities, (vi) personnel and relationships related to newly released financial services and products, (vii) country limitations for foreign exchange purchase/sales, (viii) country limitations for money transfers initiated by regulatory actions (i.e., OFAC), (ix) limitations on transfers to individuals, organizations, destinations initiated by regulatory actions (i.e., the Bank Secrecy Act), and the like.

Other examples of business policies, in by way of example, the corporate, defense, academic, non-profit, the federal world and the like, include but are not limited to, (i) unauthorized access of documents by an office worker, (ii) first time access to potentially high security documents, (iii) excessive information accessed in a short period of time, and the like.

Filter 22 can be of many different types. In one embodiment, the filter 22 is a contextual filtering system that provides different deviations for different customer profiles of individuals.

### EXAMPLE 3

In this example, a teacher uses a credit union to conduct his financial business. Given the teacher's income, the transaction amounts relative to the credit union are in the $ 100's to the 1000's. Should the system 10 notice a $10,000 transaction via the transaction network 16, the system 10 responds by creating a flag to the credit union for immediate intervention. In contrast, consider a family trust with a $100 million dollar value that regularly conducts stock transactions in the ten's of thousands of dollars. The same business event for a $10,000 transaction, being the norm for the family trust, does not trigger a flag. However, multiple transactions of $100s conducted within a short period of time (i.e., intraday) on the teacher's account, may trigger a flag, and prompt an intervention by the system 10. FIG. 3 is a flowchart that illustrates the creation/identification of business event definitions.

In another embodiment, the filter 22 is a contextual, probabilistic filtering system. In one embodiment, the filter 22 is a contextual, probabilistic, scoring filtering system.

At least one actuator 24 is used to determine deviation and/or trigger interaction in an individual's normal behavior pattern information in response to the aggregated data stream.

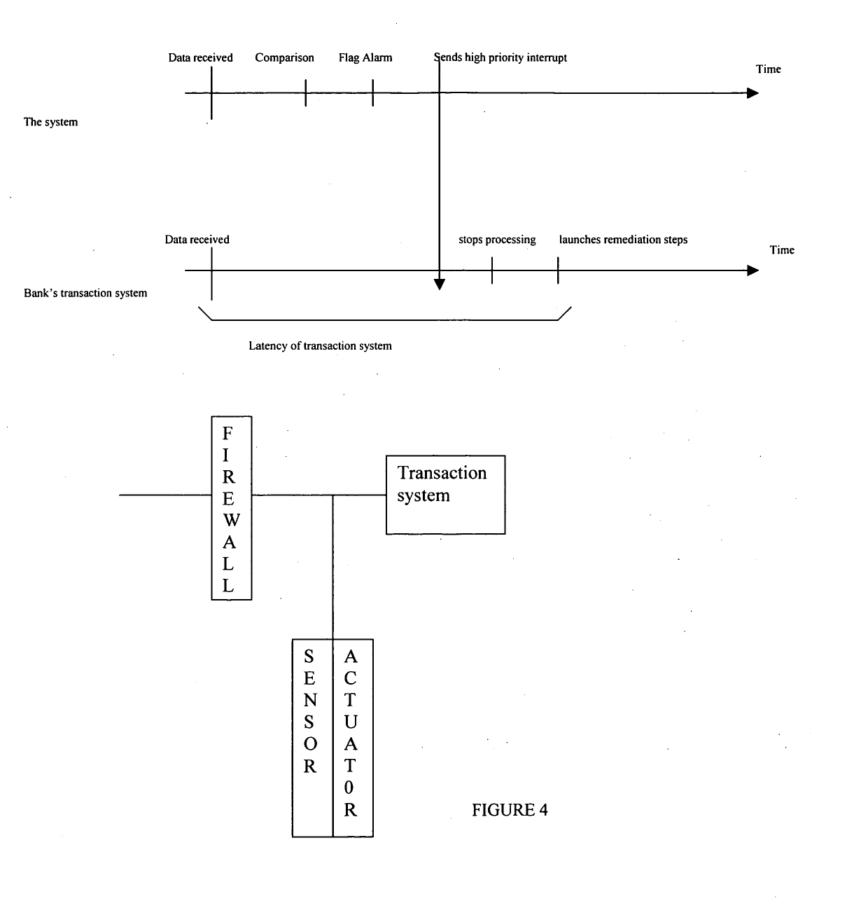

In the event of a deviation, an intervention is produced. A deviation in behavior is first detected by the system 10. In one specific embodiment, a high priority interrupt is transmitted to a transaction system 17 used by the individual for his transaction. The interrupt arrives within a latency period of the transaction network 16. Because it is a high priority interrupt, it intercepts the financial transaction, and creates an intervention. In various embodiments, the deviations are identified in real time and/or triggered in real time, as shown in FIG. 4.

In one embodiment, the transaction network 16 is a distributed network and includes the sensors 14, at least one analyzer engine 20 and more than one actuator 24. In one embodiment, all or a portion of the sensors 14, analyzer engines 20 and actuators 24 are integrated as a single unit. In this embodiment, the sensor 14 and the actuator 24 have independent connections to the transaction network 16. One connection is used to create the session data stream, while the second connection is used to communicate with the transaction system 17 used by the individual to conduct his financial transaction.

In one embodiment, the sensors 14 also perform as actuators 24 to trigger the interventions. In another embodiment, the individual's normal behavior pattern information is received at the sensors 14 from the analyzer engine 20 in real times which is the latency of the transaction network 16. In another embodiment, the analyzer engine 20 constructs the session data streams from the aggregated data stream in real time. In another embodiment, the analyzer engine 20 constructs aggregated data stream from the session data streams.

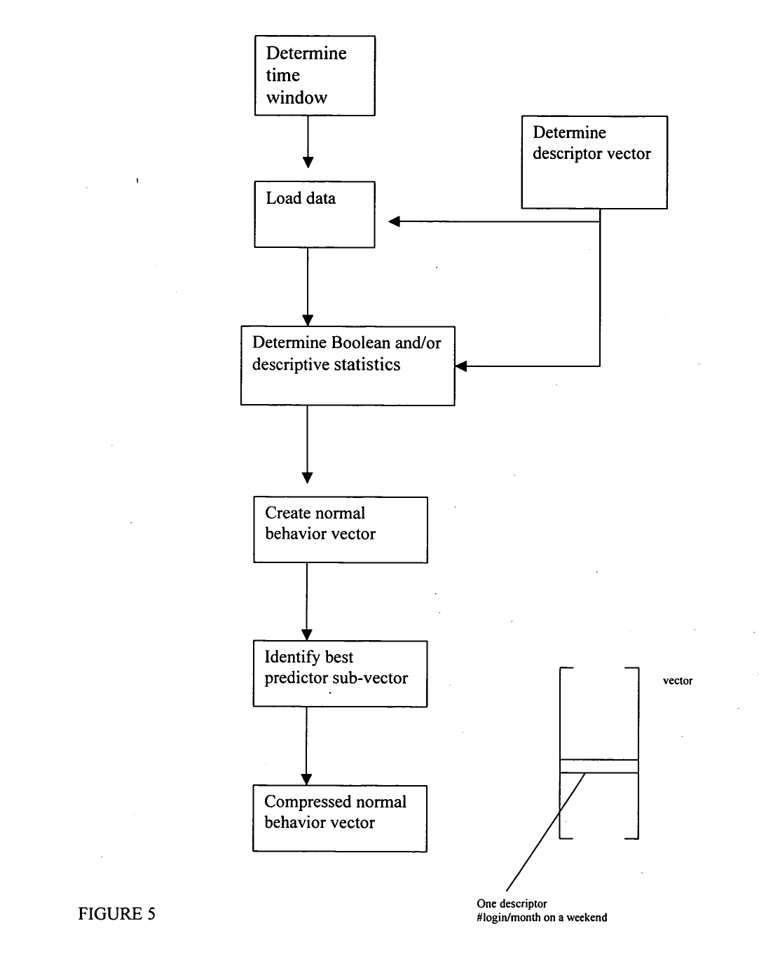

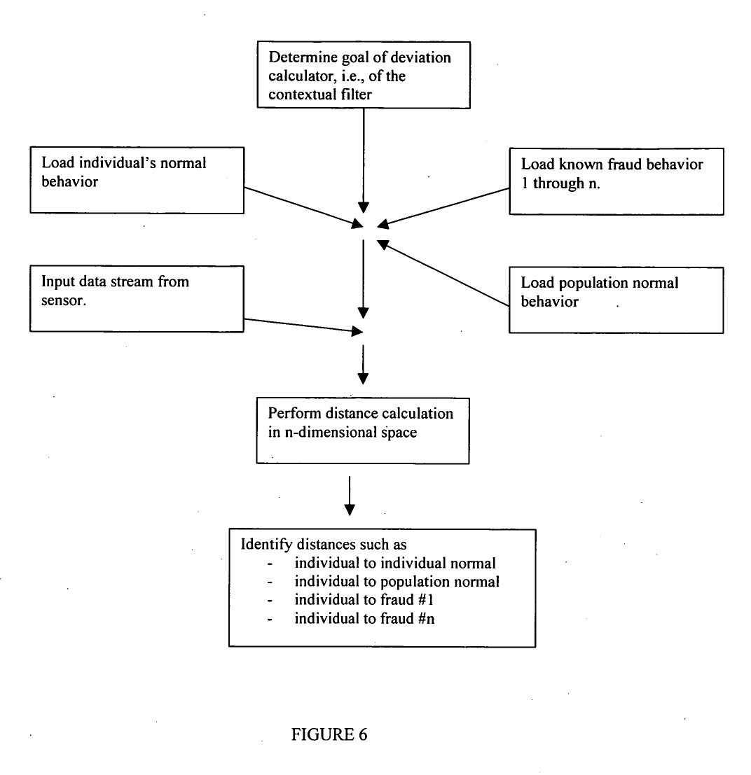

Referring now to FIGS. 5 and 6, In one embodiment of the present invention, deviations of the session data stream with respect to at least one of, the individual's normal behavior pattern information, the population's normal behavior pattern information or a known fraud pattern are determined, as described above with respect to the deviation calculation. An individual is a single person. A population is a plurality of individual's that belong to the same distributed transaction network 16. If the population is diverse, sub-groups with similar descriptive characteristics can be segmented, by a cluster analysis, and used to identify deviations. The normal behavior pattern information of the individual and population is received at the sensors 14 from the analyzer engine 20.

The individual's and the population's normal behavior pattern information is obtained as described above. A comparison is made between the individual's and/or the population's normal behavior pattern information with at least a portion of the plurality of session data streams from the sensors 14. From this comparison, the deviations are identified at the sensors 14. In one embodiment, the deviations are identified with only a portion of the session data streams.

In one embodiment, historical records of the individual's behavior pattern information are used in order to support the conclusion that an intervention is warranted. The individual's and the population's normal behavior pattern information is data compressed. In one embodiment, the most significant predictors of the behavior vector are transmitted to the sensors 14. It will be appreciated that other data compression methods can be utilized.

Deviations with respect to the individual's normal behavior pattern information, the population's normal behavior pattern information or known fraud patterns are determined. When deviations are detected, interventions are produced. The interventions can be identified and/or triggered in real time.

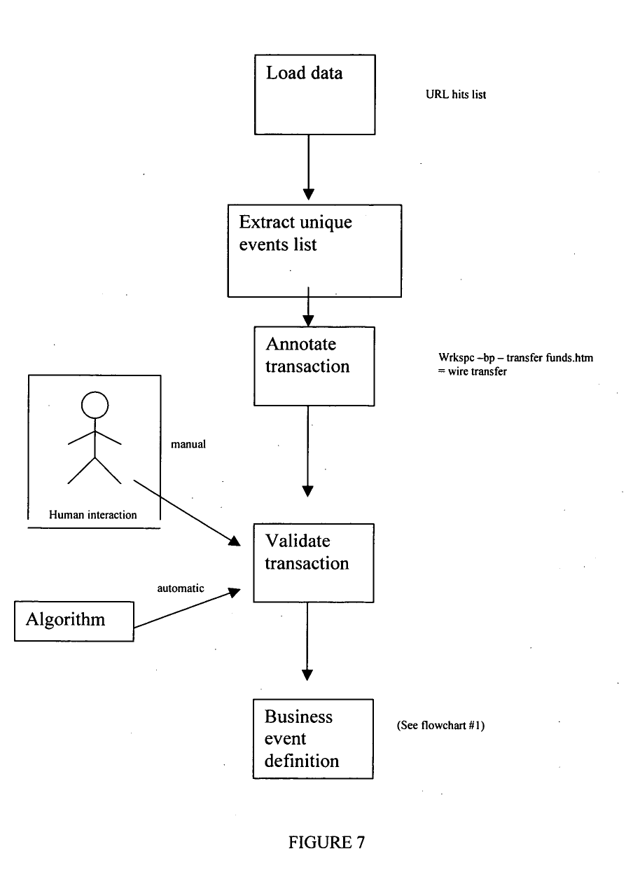

Sessions are created from the aggregated data stream. The sessions can be a reconstruction of command and payload from packets, or a reconstruction of business activities from business steps. In one embodiment, the sessions are mapped between commands and business actions by any human computer interaction mode, as illustrated in FIG. 7. In various embodiments, the sessions are manually or automatically mapped between the commands and the business actions.

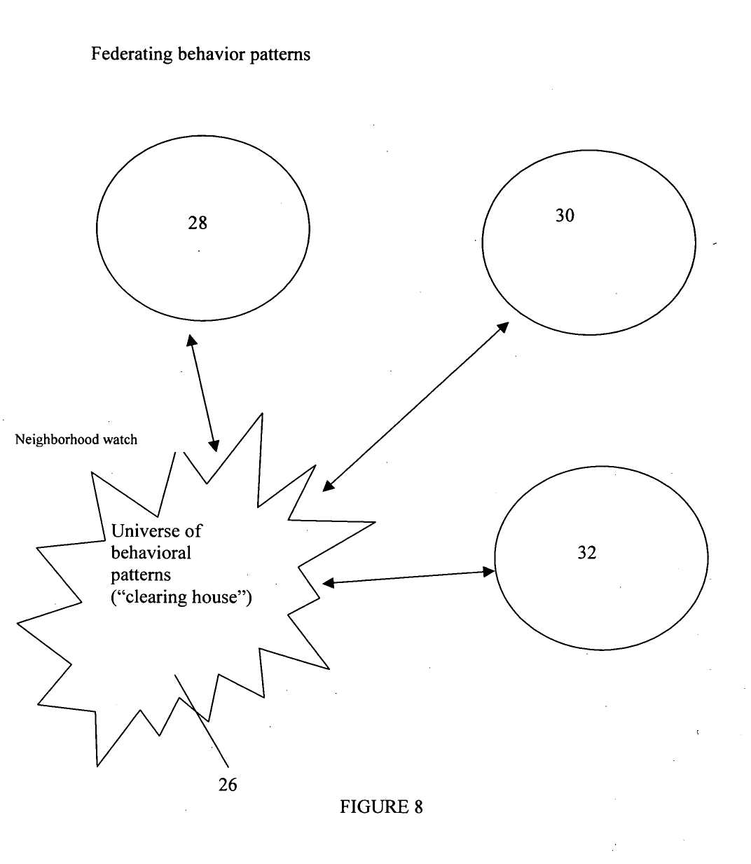

In another embodiment, illustrated in FIG. 8, deviations of interest are transmitted to a clearing house 26 and then to other transaction networks 16. As illustrated in FIG. 8, a behavior pattern information can be a sequence of steps that have been observed. In the example illustrated in FIG. 8, there are three banks 28, 30 and 32. Bank 28 is the largest financial institution and is the one most likely to be targeted by a fraudulent individual The system 10 detects new fraudulent behaviors of for example the bank 28. Having determined what those behavior patterns are, the system 10 then communicates these patterns to banks 30 and 32 via the clearing house 26. The personal information of each bank's customer is not shared in any way. Behaviors are shared, and not personal information. Therefore, data privacy is maintained, and fraudulent behaviors communication to multiple financial institutions quickly without sharing personal information. It will be appreciated that the present invention is applicable to any type of organization including but not limited to banks.

In other embodiments of the present invention, the system 10 is used for segmenting a population's behavior for marketing, audit and compliance purposes.

In another embodiment of the present invention, the system 10 is used to monitor the behavior of an application environment. Because we have mapped between URL stream and business actions, The system 10 identifies and flags changes in the application environment, e.g., an “application behavior change.” In this embodiment, normal application behaviors are identified and are monitored for deviations from this normal behavior. This embodiment is particularly suitable for service oriented architecture (“SOA”) and decentralized computing, where autonomously made changes can cause problems elsewhere. This is particularly relevant for those applications that are not notified of the change or haven't made the necessary changes to be compatible.

### EXAMPLE 4

In this example, application programmers attempt to commit a fraud by temporarily implementing tricks to defraud a company, and then moving things back to the normal state. With system 10, the normal behavior of the company is known. System 10 quickly discovers the deviations made by the application programs and flags them.

The foregoing description of embodiments of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method for conducting surveillance on a network, comprising:
capturing data for a plurality of aggregated channels, the data being from individuals with transaction network access identifiers that permit the individuals to gain access to the transaction network or from applications on a transaction network;
using the data to construct a plurality of session data streams, the session data streams providing a reconstruction of a business activity participated in by the application or the individual with the transaction network;
reading a window of data in at least one of the plurality of session data streams;
testing the window of data against at least one filter to determine deviations, the at least one filter detecting behavioral changes in the applications or the individuals that have the transaction network access identifiers to access to the transaction network; and
responding to the deviations by taking defined interventions.

2. The method of claim 1, wherein each of an aggregated channel provides information from different processes that are available on the transaction network.

3. The method of claim 2, wherein at least a portion of the different processes are separated by fire walls.

4. The method of claim 1, further comprising:
storing at least a portion of the data in one of a plurality of record files;

5. The method of claim 1, wherein the transaction network is a distributed transaction network, of sensors, analyzer engines, actuators and transaction systems.

6. The method of claim 5, wherein at least a portion of the sensors, analyzer engines and actuators are integrated as a single unit.

7. The method of claim 1, wherein the filter is determined by at least one of, a set of rules, through statistical analyses or algorithmically.

8. The method of claim 1, wherein business policies are translated to create at least a portion of the filter.

9. The method of claim 1, further comprising:
providing a plurality of sensors at different places on the transaction network to provide the plurality of session data streams.

10. The method of claim 1, further comprising:
providing a plurality of sensors and analyzer engines to provide the plurality of session data streams.

11. The method of claim 9, wherein the plurality of sensors act non-intrusively.

12. The method of claim 11, wherein non-intrusiveness is achieved without changing a robustness of the transaction network.

13. The method of claim 1 1, wherein non-intrusiveness is achieved without modifying any application code to track the data.

14. The method of claim 1, further comprising:
providing at least one analyzer engine to produce an aggregated data stream that is a sequence of process steps.

15. The method of claim 1, further comprising:
providing a plurality of analyzer engines at different places on the transaction network to produce at least one aggregated data stream.

16. The method of claim 14, wherein the analyzer engine constructs the aggregated data stream from the plurality of session data streams obtained over time.

17. The method of claim 1, wherein the plurality of session data streams includes an individual's behavior pattern information.

18. The method of claim 17, further comprising:
determining an individual's normal behavior pattern information and a population's normal behavior pattern information.

19. The method of claim 18, further comprising:
data compressing at least one of the individual's or the population's normal behavior pattern information.

20. The method of claim 18, further comprising:
determining deviations of the session data stream with respect to at least one of, the individual's normal behavior pattern information, the population's normal behavior pattern information or a known fraud pattern; and
providing interventions in response to deviations determined with respect to at least one of the individual's, the population's normal behavior pattern information or the known fraud pattern.

21. The method of claim 1, wherein the interventions are flags.

22. The method of claim 20, further comprising:
identifying deviations of the individual's behavior pattern information or the application's behavior pattern information at an analyzer engine with at least a portion of the plurality of session data streams.

23. The method of claim 18, further comprising:
receiving at least a portion of at least one of the individual's normal behavior pattern information, the population's normal behavior pattern information or the fraud known pattern at the sensors from an analyzer engine or from the analyzer engine to the sensors.

24. The method of claim 20, further comprising:
identifying deviations of the individual's behavior pattern information or the application's behavior pattern information at the sensors with at least a portion of the plurality of session data streams.

25. The method of claim 23, wherein in response to receipt of the at least a portion of the individual's normal information, the population's normal information or the known fraud pattern at the sensors, the sensors also perform as actuators to trigger interventions.

26. The method of claim 1, wherein the deviations are identified in real time.

27. The method of claim 1, wherein the interventions are triggered in real time.

28. The method of claim 14, wherein sessions are created from the aggregated data stream, wherein the sessions are a reconstruction of command and payload from packets, or a reconstruction of business activities from business steps.

29. The method of claim 28, wherein the sessions are mapped between commands and business actions by any human computer interaction mode.

30. The method of claim 29, wherein the sessions are manually mapped between the commands and the business actions.

31. The method of claim 29, wherein the sessions are automatically mapped between the commands and the business actions.

32. The method of claim 1, wherein the filter is a contextual filtering system configured to provide different deviations for different customer profiles of individuals.

33. The method of claim 32, wherein the filter is a contextual, probabilistic filtering system.

34. The method of claim 33, wherein the filter is a contextual, probabilistic, scoring filtering system.

35. The method of claim 24, wherein deviations of interest are transmitted to a clearing house and then to other transaction networks.

36. A network surveillance system, comprising:
a network;
a plurality of sensors distributed at the network configured to provide a plurality of session data streams, the session data streams providing a reconstruction of, an individual with network access identifiers that permit the individual to gain access to the network or business activity participated in by an application on the network;
at least one analyzer engine configured to receive the plurality of session data streams and produce an aggregated data stream that is a sequence of process steps;
a reader configured to read a window of data in at least one of the plurality of session data streams;
a filter that tests the window of data and detects behavioral changes in, the individual that has the network access identifiers to access the network or the application; and
at least one actuator configured to provide an intervention in response to the behavior changes.

37. The network of claim 36, further comprising:
at least one analyzer engine to produce an aggregated data stream that is a sequence of process steps.

38. The network of claim 36, further comprising:
a plurality of record files for receiving network data and storing at least a portion the data before further examination.

39. The system of claim 36, further comprising:
providing a plurality of analyzer engines at different places on the network to produce at least one aggregated data stream.

40. The network of claim 39, wherein at least a portion of the sensors, analyzer engines, actuators and systems are integrated as a single unit.

41. The system of claim 36, wherein the filter is determined through at least one of, statistical analyses, algorithmically or a set of rules.

42. The system of claim 36, wherein business policies are translated to create at least a portion of the filter.

43. The system of claim 38, wherein the analyzer engine constructs the plurality of session data streams over time.

44. The system of claim 36, wherein the plurality of session data streams includes an individual's behavior pattern information.

45. The system of claim 38, wherein the analyzer engine determines an individual's normal behavior pattern information and a population's normal behavior pattern information.

46. The system of claim 45, further comprising:
a data compressor configured to compress at least one of the individual's or the population's normal behavior pattern information.

47. The system of claim 45, wherein the analyzer engine is configured to determine deviations with respect to at least one of, the individual's normal behavior pattern information, the population's normal behavior pattern information, or the known fraud pattern.

48. The system of claim 47, wherein the actuator is configured to provide the intervention in response to determining deviations in at least one of, the individual's behavior pattern information, the population's behavior pattern information, or the known fraud pattern.

49. The system of claim 48, wherein the analyzer engine is configured to compare at least one of, the individual's normal behavior pattern information, the population's normal behavior pattern information or the known fraud pattern with at least a portion of the plurality of session data streams from the sensors, and identify deviations of the at least one of the individual's or population's behavior pattern information at the sensors with at least a portion of the plurality of session data streams.

50. The system of claim 49, wherein the analyzer engine identifies deviations of the individual's behavior pattern information with at least a portion of the plurality of session data streams.

51. The system of claim 49, wherein the deviations are identified in real time.

52. The method of claim 36, wherein the intervention are triggered in real time.

53. The system of claim 49, wherein at least a portion of at least one of the individual's normal behavior pattern information, the population's normal behavior pattern information or the known fraud pattern is received at the sensors from the analyzer engine.

54. The system of claim 49, wherein in response to receipt of the at least a portion of the individual's normal behavior information, the population's normal behavior information or the known fraud pattern at the sensors, the sensors also perform as actuators to trigger interventions.

55. The system of claim 53, wherein receiving at least a portion of the individual's normal behavior pattern information, the population's normal behavior pattern information or the known fraud pattern at the sensors from the analyzer engine is in real time.

56. The system of claim 36, wherein sessions are created from the aggregated data stream.

57. The system of claim 36, wherein the sessions are manually mapped between the commands and the business actions.

58. The method of claim 39, wherein the sessions are automatically mapped between the commands and the business actions.

59. The system of claim 39, wherein the filter is a contextual filtering system configured to provide different deviations for different customer profiles of individuals.

60. The system of claim 39, wherein the filter is a contextual, probabilistic filtering system.

61. The system of claim 39, wherein the filter is a contextual, probabilistic, scoring filtering system.

62. The system of claim 49, further comprising:
a clearing house configured to receive deviations of interest that are then provided to networks of other organizations.

63. A method for conducting surveillance on a network, comprising:
capturing data for at least one channel, the data being from, individuals with transaction network access identifiers that permit the individuals to gain access to a transaction network, or applications on the transaction network;
using the data to construct a plurality of session data streams, the session data streams providing a reconstruction of business activity participated in by the application or the individual with the transaction network, the plurality of session data streams including an individual's behavior pattern information. determining an individual's normal behavior pattern information and a population's normal behavior pattern information;
determining deviations with respect to at least one of the individual's normal behavior pattern information, the population's normal behavior pattern information and a known fraud pattern; and
providing interventions in response to determining deviations with respect to at least one of, the individual's normal behavior pattern information, the population's normal behavior pattern information or the known fraud pattern.

64. The method of claim 63, further comprising:
storing at least a portion of the data in one of a plurality of record files;

65. The method of claim 63, wherein the transaction network is a distributed transaction network of sensors, analyzer engines and actuators.

66. The method of claim 65, wherein at least a portion of the sensors, analyzer engines, actuators and transactions systems are integrated as a single unit.

67. The method of claim 63, further comprising:
providing a filter that is determined through at least one of, statistical analyses, algorithmically or a set of rules,.

68. The method of claim 63, wherein business policies are translated to create at least a portion of the filter.

69. The method of claim 63, further comprising:
providing a plurality of sensors at different places on the transaction network to provide the plurality of session data streams.

70. The method of claim 63, further comprising:
providing a plurality of sensors and analyzer engines to provide the plurality of session data streams.

71. The method of claim 69, wherein the plurality of sensors act non-intrusively.

72. The method of claim 69, wherein non-intrusiveness is achieved without changing a robustness of the transaction network.

73. The method of claim 69, wherein non-intrusiveness is achieved without modifying any application code to track the data.

74. The method of claim 69, further comprising:
providing at least one analyzer engine to produce an aggregated data stream that is a sequence of process steps.

75. The method of claim 63, further comprising:
providing a plurality of analyzer engines at different places on the transaction network to produce at least one aggregated data stream.

76. The method of claim 63, further comprising:
data compressing at least one of the individual's or the population's normal behavior pattern information.

77. The method of claim 63, wherein the interventions are flags.

78. The method of claim 63, wherein the deviations are identified in real time.

79. The method of claim 63, wherein the interventions are triggered in real time.

80. The method of claim 74, further comprising:
receiving at least a portion of at least one of the individual's normal behavior pattern information, the population's normal behavior pattern information or the known fraud pattern at the sensors from the analyzer engine.

81. The method of claim 80, wherein in response to receipt of the at least a portion of the individual's normal behavior information, the population's normal behavior information or the known fraud behavior at the sensors, the sensors also perform as actuators to trigger interventions.

82. The method of claim 81, wherein the at least a portion of the individual's normal behavior pattern information, the population's normal behavior pattern information or the known fraud pattern are received at the sensors is received from the analyzer engine in real time.

83. The method of claim 80, wherein the analyzer engine constructs the plurality of session data streams from the aggregated data stream in real time.

84. The method of claim 63, wherein the analyzer engine constructs the aggregated data stream from the plurality of session data streams.

85. The method of claim 74, wherein sessions are created from the aggregated data stream, wherein the sessions are a reconstruction of command and payload from packets, or a reconstruction of business activities from business steps.

86. The method of claim 85, wherein the sessions are mapped between commands and business actions by any human computer interaction mode.

87. The method of claim 86, wherein the sessions are manually mapped between the commands and the business actions.

88. The method of claim 86, wherein the sessions are automatically mapped between the commands and the business actions.

89. The method of claim 67, wherein the filter is a contextual filtering system configured to provide different deviations for different customer profiles of individuals.

90. The method of claim 67, wherein the filter is a contextual, probabilistic filtering system.

91. The method of claim 67, wherein the filter is a contextual, probabilistic, scoring filtering system.

92. The method of claim 78, wherein deviations of interest are transmitted to a clearing house and then to networks of other organizations.
